(19) United States
(12) Patent Application Publication
(10) Pub. No.: US 2008/0038455 A1
(43) Pub. Date: Feb. 14, 2008

(54) Multilayer Optical Disc and Method and Apparatus For Making Same

(75) Inventors: Eugene Levich, Tel-Aviv (IL); Vladimir Binyukov, Moscow (RU); Sergei Magnitskii, Moscow (RU); Dmitry Malakhov, Moscow (RU)

Correspondence Address: MCCORMICK, PAULDING & HUBER LLP, CITY PLACE II, 185 ASYLUM STREET, HARTFORD, CT, 06103, US

(73) Assignee: NNE, INC., London (GB)

(21) Appl. No.: 11/631,732

(22) PCT Filed: Jul. 7, 2005
(86) PCT No.: PCT/IL05/00728

§ 371 Date: Oct. 5, 2007

Related U.S. Application Data
(60) Provisional application No. 60/585,574, filed on Jul. 7, 2004.
(60) Provisional application No. 60/631,222, filed on Nov. 29, 2004.

(51) Int. Cl. B05D 5/06

(52) U.S. Cl. 427/162

(57) ABSTRACT

Multilayer Optical Disc and Method and Apparatus for making same are proposed The technology provides increasing the number of layers in reflective optical disks of any format. The technology allows producing of multilayer optical reflective discs of any format (CD, ROM, DVD ROM, Blue Ray, HD-DVD, DVD-R, DVD-RW, etc.) using existing CD/DVD production lines with reasonable upgrading.

### BACKGROUND OF THE INVENTION

The invention relates to the field of information storage devices in general, and more particularly to multilayer optical discs and methods for making them including mass production.

Optical systems of information storage provide for storing large volumes of various data as well as ways recording and reading thereof.

HDTV, HD-video and high-speed Internet require inexpensive carriers with high recording capacity. The data recording density on one layer can be increased by way of using a shorter laser wave length and, respectively, smaller pit sizes. Another way is to increase the number of data layers, that is, to use a multilayer disc. Conventional DVDs have at most 2 layers on one side of the disk.

Reading from optical information storage devices is usually carried out by a laser beam focused on one of the data layers with further registration of the reflected beam modulated with the pit-and-land pattern.

The U.S. Pat. Nos. 4,090,031; 4,219,704 to Russel feature a multilayer optical disc with the layers containing recorded information on one side of the disk, and the laser beam scans the data recorded along the tracks either in the digital or analog form. The reading device of such a disc was designed so that the reading beam could focus on each layer in turn. The source of the reading light and detecting system were for the first time placed on one side of the disk. That was why, though they provided for the opportunity to make transparent layers (with different optical transmission capacities or made of different dyes or photo-luminescent materials), preference was given to reflective coatings. The reading device readjusted from one layer to another either by changing the lens focus or changing the light filters (if the layers were made of the materials containing different dyes or photo-luminescent materials).

The U.S. Pat. No. 4,450,553 assigned to Philips mentions the chance to create a multi- (at least a two-) layer disc by covering the data layer relief with dielectric layer with the reflection factor from 20% to 60% depending on the layer's number, that doesn't absorb at the laser wave length, or with a thin metal coating whose thickness and material are determined so that each layer's signals were approximately equal (based on the public print data). The examples of dielectric coatings are zinc selenide, bismuth oxide, cadmium sulphide, cadmium telluride, and their combination.

The U.S. Pat. Nos. 5,255,262; 5,202,875; 5,373,499; 5,446,723; 5,610,901; 5,666,344 assigned to the IBM relating to multilayer discs and respective drivers point out that all the prior systems used to be very complicated concerning reading the data from different layers by way of changing the lens' focus distance and removing cross talks from the neighboring layers and generation of the tracking signal. The authors offer a simpler system and physical grounds for the said schemes to function. At the same time the patents don't mention any definite technology of the disc manufacture.

Reference may be had to U.S. Pat. No. 5,255,262 which discloses an optical disc consisting of many substrates with information layers separated by either air or transparent 100-300-mμ thick solid-state layers with a different refraction factor. Only the last data surface is covered with a fully reflective coating. The upper substrate (through which the laser signal comes) is 1.2 mm thick, the rest are 0.4 mm (generally from 0.2 to 0.8 mm) thick. As an option, the layers' transmission is 96% (no coating) leading to the reduction of spurioustic signals from neighboring layers. To reduce the necessary laser power the data layers are to be covered with dielectric coatings achieving the reflection from 4% (λ/2n) to 20% (λ/4n), with n—the reflection factor. ZrO₂ ZrS, SiN and the oxides mixtures are to be used as dielectric coatings. The patent also emphasizes an opportunity to make data layers like WORM and recordable type (phase-change, magneto-optics), as well as their combinations. It gives a detailed description of getting the tracking signal. The drive uses a semi-conductor laser with 780-nm wavelength and an aberration compensator; the position of the focusing lens (with NA 0.55) was set by the servo-system. The compensator had a stepped design, the first step was 0.4 mm thick, the second—0.8 mm and the third—1.2 MM thick (they consider different types of such compensators).

Reference may be had to the U.S. Pat. No. 5,373,499 considering rather a difficult method of spherical aberration elimination for a multilayer disc by way of selecting thicknesses and reflection factors so that the optical lengths were the same while reading each information layer.

Reference may also be had to the U.S. Pat. No. 5,666,344 disclosing 2 layer disk, where the first data surface is deposited with some semi-conductor coating (containing C, Si, Ge, Sn, Pb or amorphous Si), as well as compounds like AB, with B=N, P, As, Sb, Bi, and A=B, Al, Ga, In, Tl, B, etc., and above them—with the protecting layer of a transparent dielectric. The layers' thickness was equal to 25-5000 A The co-inventors pointed out, that the intensity of the light reflected from each data layer had to be the same.

Producing conventional dual-layer discs DVD-9 one can use both the regular process of injection molding in conventional moulds (based on technology disclosed in, U.S. Pat. No. 5,876,823 assigned to Matsushita Corporation), and the modified so-called 2P process (stamping of photopolymer), disclosed in U.S. Pat. No. 6,117,284 assigned to WAMO company). In the first case the information layer is stamped on the first DVD substrate (0.6 mm) using an injecting molding, and further covered by deposited partially-reflective coating (e.g. Au, Ag or Si), and separately, the same method is used to make the relief of the second data layer on the second DVD-substrate (0.6 mm), which is further covered with a fully reflective coating. Then both the substrates are glued “back to back”.

In accordance with the second method, the substrate with the relief of the 1^{st} data layer is first covered with a semi-reflective coating, then with a UV-cured photopolymer; then the second stamper is stamped into it, UV-cured, making as a result the second data layer. Later the stamper is separated, the second data layer is covered with a reflective coating and a layer of adhesive. In case of DVD-9 the next step being sticking a blank substrate, and in case of DVD-14, the second substrate with a single information layer, and with DVD-18—the second half of the “sandwich” including 3^{rd} and 4^{th} data layers manufactured in a similar way.

To this end, manufacturing of DVD-9 (dual-layer, single-sided), injection molding in conventional moulds (Matsushita) method includes steps:

| | |
|---|---|
| 1. | Injection molding of the polycarbonate substrate with the relief of the |
| | 1^{st} data layer with the help of the 1^{st} nickel stamper; |
| 2. | Deposition of a partially-reflective coating on the relief of the 1^{st} data |
| | layer; |
| 3. | Injection molding of the 2^{nd} polycarbonate substrate with the relief of |
| | the 2^{nd} data layer using of the 2^{nd} nickel stamper; |
| 4. | Deposition of a reflective coating on the relief of the 2^{nd} data layer; |
| 5. | Gluing the two substrates with their information layers inside; |

Manufacturing of DVD-9 in accordance with modified 2P process (WAMO) method includes steps:

| | |
|---|---|
| 1. | Injection molding of the polycarbonate substrate with the relief of the 1^{st} data layer |
| | using of the 1^{st} nickel stamper; |
| 2. | Deposition of a partially-reflective coating on the relief of the 1^{st} data layer; |
| 3. | Injection molding of the PMMA substrate with the relief of the 2^{nd} data layer using |
| | of the 2^{nd} nickel stamper; |
| 4. | Deposition of an adhesive UV-cured photopolymer on the 1^{st} data; |
| 5. | Deposition of a fully reflective coating on the relief of the 2^{nd} data layer; |
| 6. | The UV-light curing of the photopolymer; |
| 7. | Separating the 2^{nd} substrate, leaving the 1^{st} one with the 1^{st} and 2^{nd} data layers with |
| | the respective reflective coatings; |
| 8. | Gluing a blank (without data layers) polycarbonate substrate above the relief of the |
| | 2^{nd} data layer; |

DVD-9 can be manufactured by both the 1^{st} and 2^{nd} methods, whereas DVD-14 and DVD-18 (double-sided 3- or 4-layer discs respectively) require only the WAMO technology. Some companies to produce DVD-9 and DVD-18 use it.

Reference may be had to U.S. Pat. No. 6,177,168 which discloses modified method of manufacturing a 4-layer sandwich (2 layers, 2 sides) with outer substrates with the 1^{st} and last information relieves made in a conventional way—injection molding with further sputtering partially-reflective layers. The middle of the sandwich is made using the same equipment as for the 1^{st} and last layers but stampers (with the relief of the 2^{nd} and 3^{rd} data layers) are fixed both from the press and the base sides of the mould, as a result these data relieves will be stamped on the inner-layer (made from the stuff of not compulsory optical quality) and later coated with a reflective material. Then the said layer is glued between the two substrates with the 1^{st} and 4^{th} data layers made beforehand and we have a four-layer disc (double-sided, with two layers on each side).

Reference may also be had to U.S. Pat. No. 6,309,496 assigned to WAMO Corporation, which describes the technology of manufacturing DVD-14 and DVD-18 discs using a plastic matrix for transferring the data relief.

The WAMO technology to produce double-sided 3- or 4-layer discs includes steps:

| | |
|---|---|
| 1. | Injection molding of a 0.6 mm-thick polycarbonate substrate with the 1^{st} data layer |
| | (mother-type) with the help of the 1^{st} stamper (father-type); |
| 2. | Deposition of a partially-reflective coating on the relief of the 1^{st} data layer; |
| 3. | Injection molding of PMMA substrate (making a plastic father-matrix) with the |
| | relief of the 2^{nd} information layer using the nickel stamper (mother); |
| 4. | Deposition of the anti-adhesive coating on the plastic matrix (option); |
| 5. | Sticking the plastic matrix and substrate to the 1^{st} layer using PhP cured with UV- |
| | light while rotating (similar to the DVD-bonding-process); |
| 6. | Separating the plastic matrix, releasing the “sandwich” - the substrate with the 1^{st} |
| | data layer + the relief of the 2^{nd} layer with a reflective coating transferred from the plastic |
| | matrix to photopolymer (the matrix is ready for further use); |
| 7. | Deposition of a reflective coating on the plastic matrix above the anti-adhesive; |
| 8. | Gluing a single-layer (for DVD-14) or dual-layer (for DVD-18) sandwich to this |
| | sandwich made in a similar way. |

Currently most lines producing 2-, 3-, and 4-layer DVDs use the above-described WAMO technology (see e.g., www.technicolor.com/images/TCP/content/DVDDummies.pdf).

Referring to FIGS. 1 and 2 there is shown a conventional WAMO method of a two-layer single-side DVD disc manufacturing. Injection molding from the Ni-stamper is used to form a substrate of PMMA 10 with the data-carrying relief of the 2^{nd} layer 11. Then the substrate is sputtered with a fully-reflective layer 12 (Al). Simultaneously, by way of injection molding a polycarbonate substrate 14 with the data-carrying relief of the 1^{st} layer 13 is produced. Later, the substrate is sputtered with a partially reflective layer 15. The polycarbonate substrate 14 and the one of PMMA 10 with respective information layers are glued by way of DVD-bonding with the data layers inside using the UV-cured photopolymeric glue 16. Afterwards, the substrate 10 is separated and the reflective layer 12 is transferred to the polycarbonate substrate 14. Another polycarbonate substrate 17 is glued above this sandwich with substrate 10 ready for further use.

The described method of manufacturing multilayer discs has a number of disadvantages, namely: a low output of valid discs connected with a high degree of faultiness while separating substrate 10 and transferring super thin (less than 50 μm) reflective layer 12 to the polycarbonate substrate, as well as a chance of further breaking or deforming the data layer 12 due to the shrinkage of photopolymeric glue 16. Besides, the said method is inapplicable to manufacturing discs with more than 2 layers on one side.

The recent time has seen many events in the field of multilayer discs production. At least three production standards for multilayer single-sided discs with the capacity over 14-15 GB have started competing with each other on the market of HDTV applications and high-speed Internet (100 Gb/sec). On the one hand, the Consortium (9 leading companies manufacturing discs, drives and computers) has developed and adopted the standard of the so-called Blue-ray disc (13D, capacity—up to 27 GB—single-sided, one-layer, up to 50—single-sided, two-layer). At the same time Toshiba and NEC have developed the AOD standard (Advanced Optical Disc 15 GB, single-layer, 30 GB—two-layer), and DVD-Forum has adopted the said standard as the basic one for the further DVD generation. Both systems imply using the blue laser diode with the wavelength of 405 nm (it is still fairly expensive, monopolized by the Nichia company).

The Consortium plans to use a high-aperture lens (NA=0.85), setting strict requirements for the distance between the lens and the data layers. That is why the Blue-ray disc consists of one “half” 1.1-mm thick with data layers and the protective layer 0.1-mm thick of a super hard stuff rather than of two approximately equal halves, each 0.6-mm thick. The said thin layer doesn't protect from scratches while being taken by hand, that is why the manufacturers plan to place discs in cartridges that makes them inconvenient to use. Toshiba and NEC also plan to use the blue laser to increase the recording density in their AOD disc though wish to rely on the conventional methods of two-layer DVDs and use the drives with the lens with NA=0.65. Both systems are to have the reading speed of 36 Mb/sec.

And, finally, the EVD standard (Enhanced Versatile Disk) is being developed by Taiwanese and Chinese manufacturers using the red laser but a different compression format (VP-5, VP-6, rather than MPEG-2), allowing increasing the volume of the stored information up to 9 Gbit per layer.

All the new formats (except EVD) usually imply a transfer to another technology stage—minimum pits in Blue-ray discs, e.g., must have the size of 0.58 μm, and the distance between the tracks—0.32 μm, the distance from the lens to the data layer—100 μm. All this complicates the process of the whole system (disc+drive) manufacture. At the same time a two-hour long movie in the HD TV format by MPEG-2 compression takes some 15 GB, so the capacity offered by all “blue discs” formats is obviously excessive.

### SUMMARY OF THE INVENTION

There is a need in the art to provide a novel method for manufacturing of a multilayer optical information carriers, particularly such a method that is suitable for mass production of the multi-layered optical memory devices.

This invention offers a method and technology to manufacture multilayer reflective discs with high recording density in every layer. By the said method in the framework of every format of a single-/dual-layer disc its manufacture technology changes so that there appears a chance to increase the number of data layers to 3, 4 and more without changing their optical properties and, hence, double, triple, quadruple, etc. the volume of data on the disc compared with a single-layer disc. The recording format on each layer can remain the same as it used to be on a respective single-layer disk. Besides, the said technology applies technological methods that make it possible to set up production lines manufacturing multilayer disks by way of just upgrading the lines designed for the respective single-/dual-layer discs.

Instead of the fully reflective layer (coated with, e.g., metal in a single-layer disc) or partially reflective (˜30%, coated, e.g., with a semiconductor) the 2^{nd} layer and the fully reflective first layer coated with, e.g., metal in a dual-layer disc, all the layers of a multi-layer optical disc are coated with a thin layer of, e.g., dielectric, like DLC, creating a low (˜fractions and single digits percent) reflection factor. Of importance is that all the layers including the last one have practically the same reflection factors.

### BRIEF DESCRIPTION OF THE DRAWINGS

FIGS. 1 and 2 depict a prior art WAMO technology of producing two-layer one-side (DVD) disc;

FIGS. 3-6 depict the steps for making a multi-layer optical disc in accordance with the principles of present invention; and

FIG. 7 depicts the steps for pulling away stamper from multilayer structure.

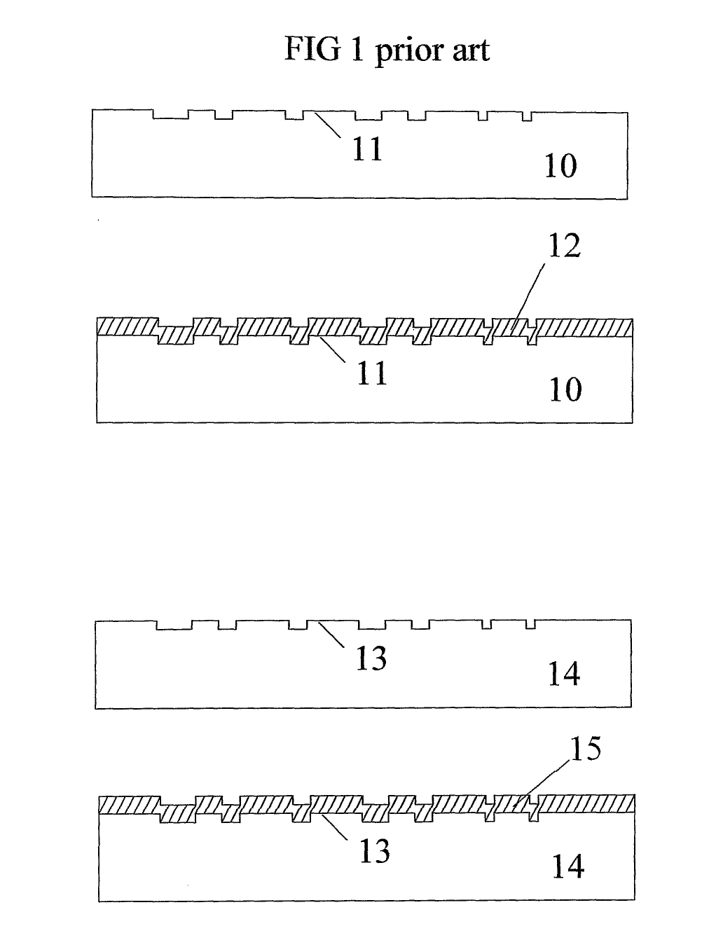

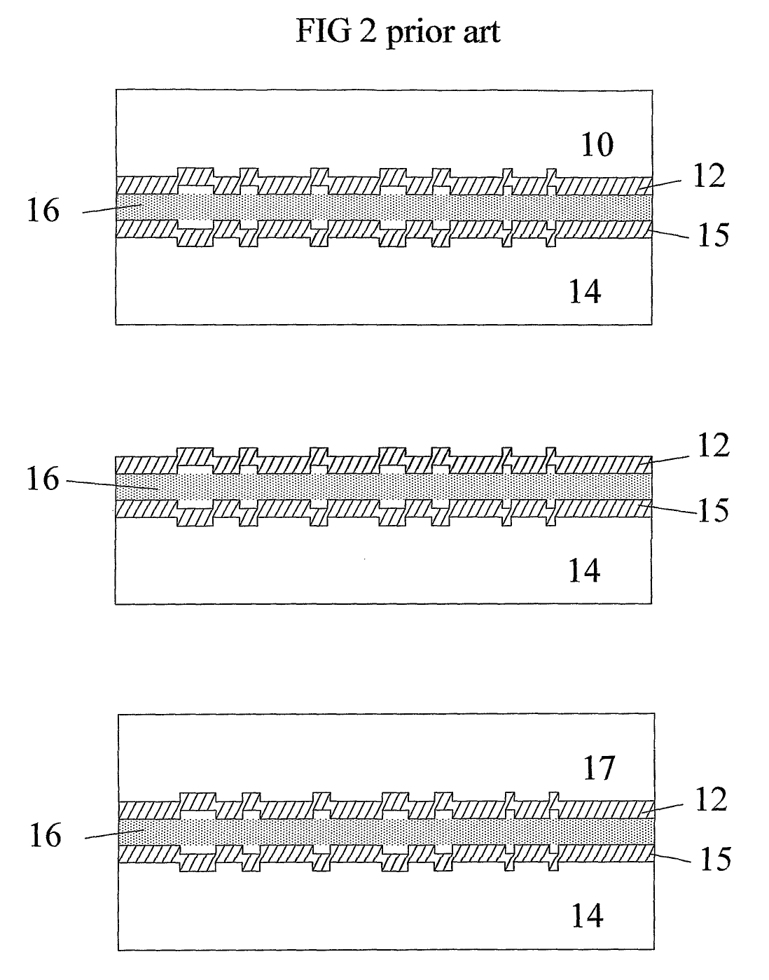

### DETAILED DESCRIPTION OF THE PREFERRED EMBODIMENTS DETAILED DESCRIPTION OF THE PREFERRED EMBODIMENTS

The proposed method of producing multilayer disks enables on the one hand to avoid shortcomings inhering the method of producing such disks under the technology WAMO, on the other hand it mostly enables to use the conventional DVD machinery (injecting molding, bonding, deposition, etc.) for manufacturing one-side multi-layer optical discs.

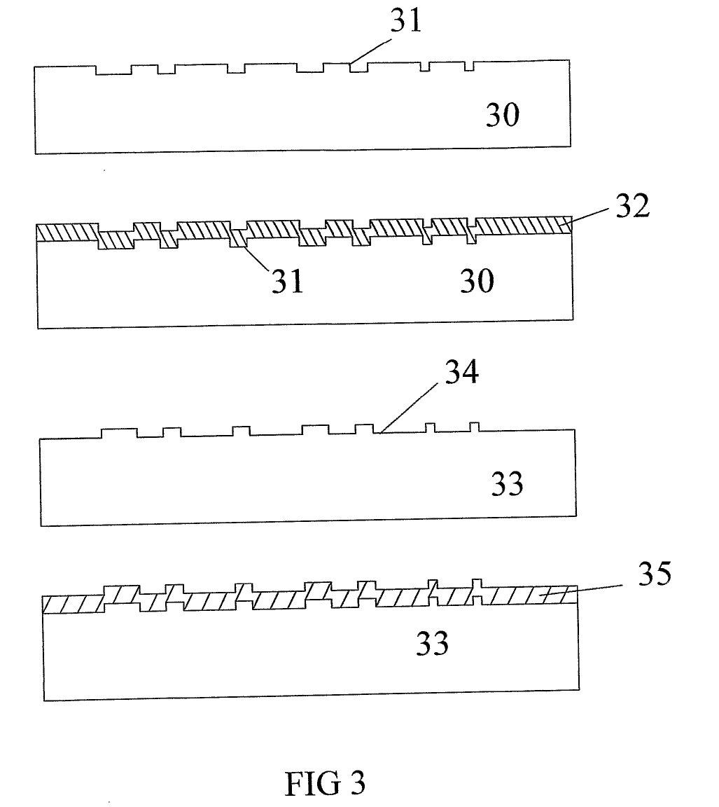

The method of the invention, for making a multi-layer disc using injection molding equipment without requiring additional equipment, is shown in FIGS. 3-7.

The initial steps in this process, shown in FIG. 3, are to use an injection molding to form a polycarbonate substrate 30 with partly reflective covering layer 32 (preferably DLC) and plastic matrix 33 preferably covered with anti-adhesion layer 35 (e.g. SiO2).

What is depicted here are the steps in forming by the method of injection molding with Ni-stamper a substrate, for example, out of polycarbonate 30 with data-bearing surface 31. Low-reflective film 32 is deposited on the substrate, for example, DLC. Similarly, by using the method injection molding, a plastic (e.g. polycarbonate) matrix 33 is made, which has data-bearing relief 34. Additionally, an anti-adhesion coating 35 is brought, e.g. SiO₂, with subsequent processing by e.g. dimethyldichloresilane.

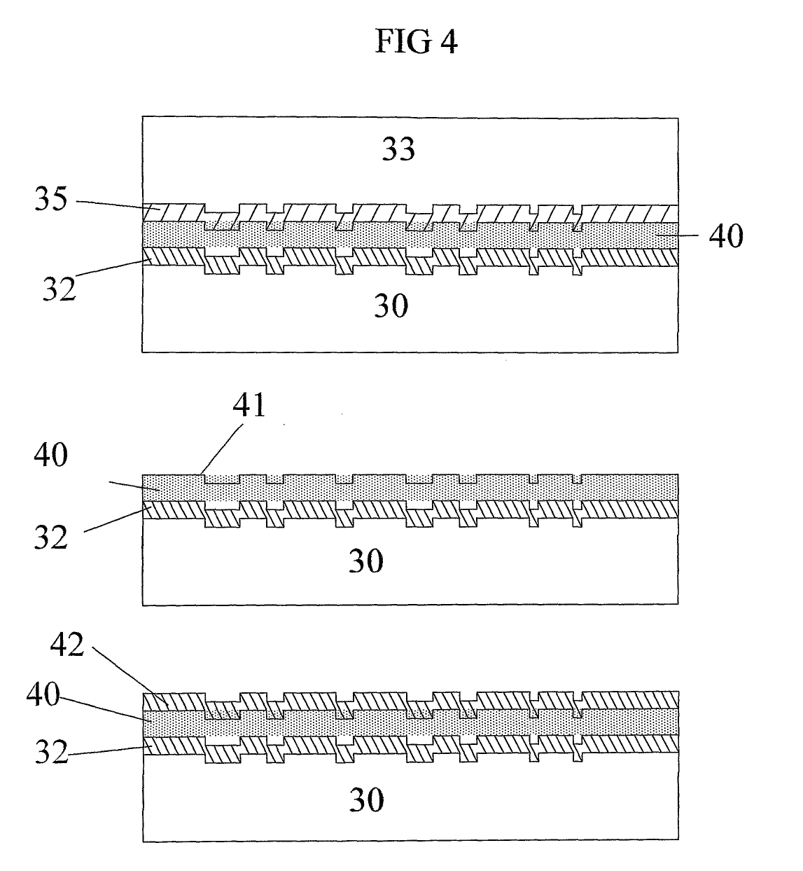

Referring to FIG. 4 there are shown the process of conglutination of plastic matrix 33 with substrate 30 having data layer 32 by the method of DVD-bonding using photopolymer glue 40, which has low shrinkage and may consist e.g. of diacrylate polyethylene glycol. The plastic matrix 33 is then pulled away in order to form data-bearing relief 41 of the second layer. Further, data-bearing relief 41 is covered by low-reflective coating layer 42, e.g. DLC.

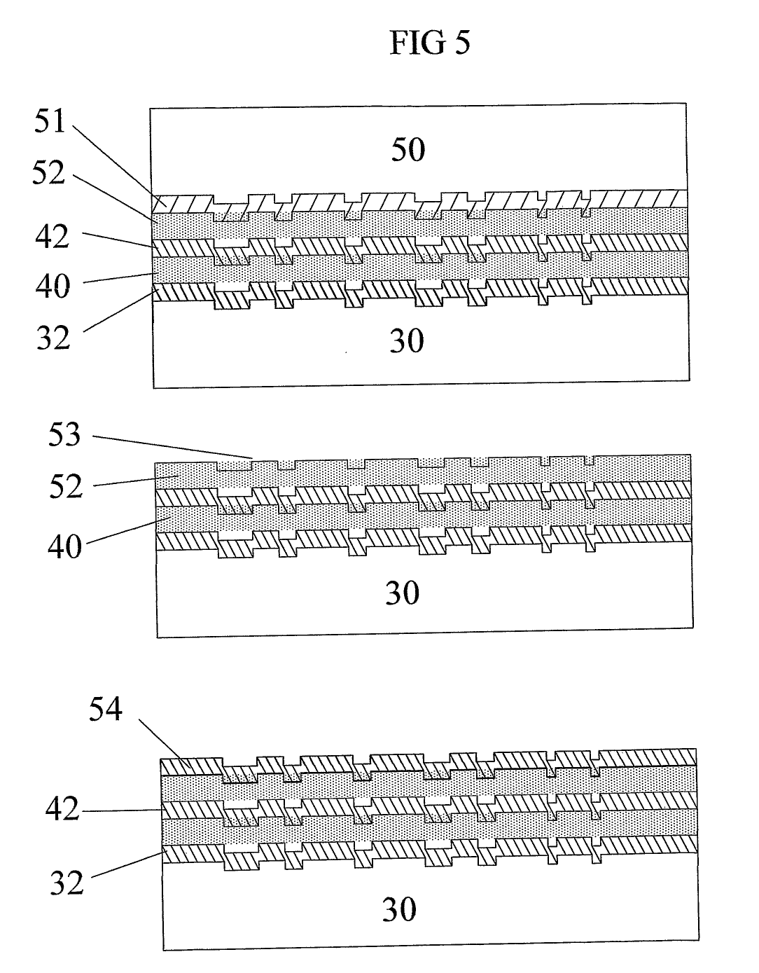

FIG. 5 illustrates the process of forming the third data layer. Plastic matrix 50, preferably having an anti-adhesion coating 51 (e.g. SiO₂, additionally processed by e.g. dimethyldichloresilane) made similar to matrix 33, is further glued by the method of DVD-bonding by photopolymer 52, and then is pulled away, forming data relief of the third layer 53. Low-reflective coating 54 (preferably DLC) is sputtered on relief 53.

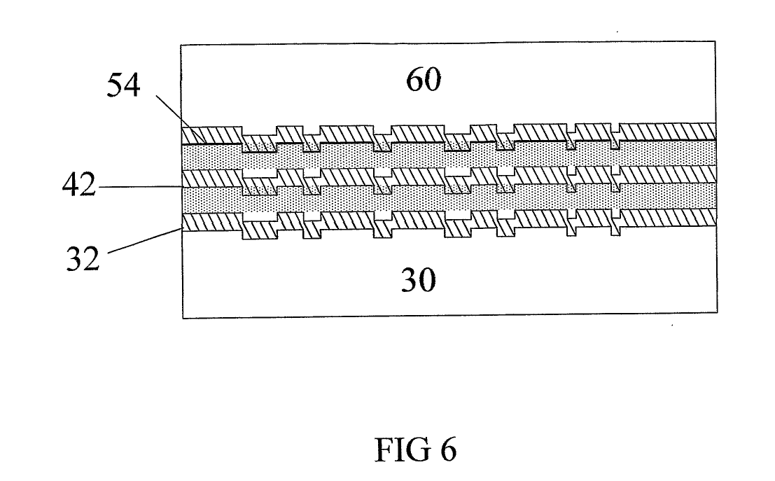

The complete structure of three-layer one-side disc 80 is shown in FIG. 6. Functions of all layers and relives are explained in previous figures. Substrate 30 with three data layers is stuck with blank substrate 60 using standard DVD-bonding step. Similarly, required quantity of data layers can be formed.

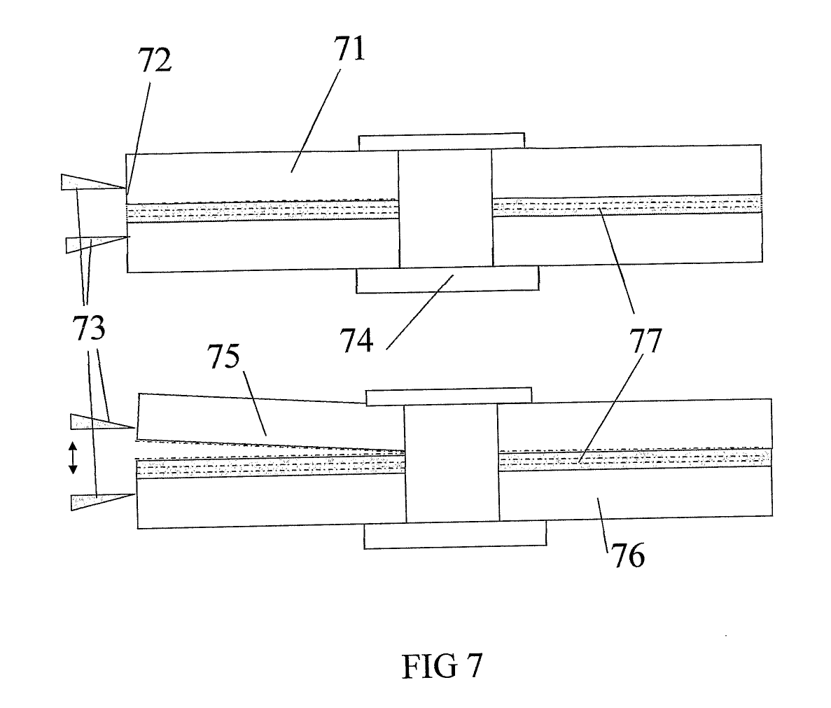

Referring to FIG. 7, there is illustrated an example of step of pulling away matrix 75 from substrate 76 with data layer 77. Disk 71, consisting of substrate with data layers 76 and plastic matrix 75, are gripped in holder 74, two needles 73 are placed from side surface of disk 72. After needles 73 are set against side surface 72, they move apart, which leads to dividing the disk into two parts along the line of anti-adhesion deposition on the plastic matrix, i.e. separating the matrix from substrate with transferred data layers. Alternatively, one needle 73 can be used. After it is set against surface 72, it shifts relative to holder 74, that leads to tearing off the matrix from the disk.

In accordance with another embodiment, multi-layer disc may be formed by technique, similar to above-mentioned WAMO technology used for manufacturing 3-, and 4-layer DVD. To this end, required number of single-layer (similar to DVD-14) or dual-layer (similar to DVD-18) “sandwiches” are formed by the above-described technique and further bonded with each other.

Standard DVD ROMs with the density of 4.7 GB per layer is adaptable for at least 5 GB (and even 6 GB) per layer if the drive's lens aperture is increased to 0.65, as is typical for DVD-R drives. The invented technology allows upgrading standard DVD production line into production line operating with accordance with the present invention for manufacturing of multilayer reflective discs with desired capacity, e.g.:
3-layer reflective optical disc with capacity 15 GB;
4-layer reflective optical disc with capacity 20 GB;
5-layer reflective optical disc with capacity 25 GB;
6-layer reflective optical disc with capacity 30 GB, etc.

Also, this technology might be used for manufacturing optical discs working on blue lasers (Blue Ray disks, Sony and Consortium), (some 20-25 GB per layer). It allows upgrading the production lines in order to launch the manufacture of dual-layer (40-50 GB), three-layer (60-75 GB), etc. optical discs.

This technology may be used for manufacturing of any kind of optical discs of the reflective type (CD, DVD-type, ROM, RW, WORM) that currently exist or will be designed in the near future; as to the wavelength.

As it has already been pointed out, the disclosed technology was designed with due regard for the technological capacities of the drive industry. The drives reading multilayer reflective discs can also be produced by the currently existing lines by their upgrading. Multilayer optical disc with desired capacity and combination of different types of layers (read-only, recordable, rewritable) could be manufactured in accordance with the present invention for different applications e.g. HDTV, 3-D TV, Computer Games, etc.

Three examples of the technique of FIG. 3-6 will be disclosed.

### EXAMPLE 1

The method of sputtering of DLC layer. 10 substrates with diameter 120 mm, thickness 0.54 mm made out of polycarbonate by injection molding and containing data in form of pits 0.12 μm deep, are placed on the low electrode of the Plasma Enhanced Chemical Vapor Deposition plant of condenser type, the temperature of which is maintained substantially 30° C. using built-in thermostat. Constant-temperature of electrode is needed for keeping substrates from possible fluctuations and overheating while they are being sputtered, which can cause heterogeneous sputtering. A layer of diamond-like carbon (DLC) is deposited on the substrate under the following conditions: reaction chamber gets vapors of acetonitril 1.5 lph, argon 1 lph, with vacuum 20 Pa, generator power is 500 Watt, frequency of generator work is 400 kHz. Time of sputtering is 6 min. In industrial setup the same effects and much faster are achieved by application of sputtering machines.

### EXAMPLE 2

The method of producing plastic matrix. Polycarbonate substrate, made by injection molding, containing data in the form of micro-bumps of 0.12 μm high (made using metal stamper—“mother”) is placed on the lower thermo stated electrode of the reaction chamber in PEVCD plant, then it is being spattered by SiO₂ under the following conditions: the reaction chamber gets vapors of hexamethyldisilazane 0.9 lph, argon 1.0 lph and oxygen 1.5 lph, with pressure in the chamber of 25 Pa and power 300 Watt for 1 hour the sputtering of SiO₂ is being carried out. Then the substrate is processed by liquid dimethyldichloresilane for 15 sec, after that the surplus of the later is removed in spin dryer and surface is washed by isopropyl alcohol. The matrix is ready for further use.

### EXAMPLE 3

In the DVD-bonding machine the substrate with sputtered layer of DLC (the first data layer) similar to example 1 is stuck with plastic matrix with data of the second layer, produced according to example 2. The thickness of the glue layer is set to be 35-40 μm. 30 min after gluing the disk is divided into layers and the data relief from plastic matrix is carried to substrate with sputtered DLC, moreover plastic matrix is released, and then this matrix can be used again for producing the next disk. To remove electrostatic stress surfaces of substrate and matrix are washed by isopropyl alcohol. On the produced half-finished product of two-layer disk according to method sited in example 1, the second coating of DLC is sputtered and then it is stuck by DVD-bonding machine with the plastic matrix bearing information of the third layer. After separating the produced half-finished disk is washed by isopropyl alcohol and stuck with a blank polycarbonate substrate in DVD bonding machine, forming three-layer disk.

It should be especially emphasized that all and every process that is described in the present invention by application of plasma deposition is achieved as well by sputtering. Also the time scale of the processes described above can be varied widely, depending on the machinery used to speed up the manufacturing process to required standards. Multilayer optical disk of ROM-type with at least one information layer, structure and method of layers combination enabling to suppress inter-layer cross-talks below the standard level of ordinary two-layer DVD-discs. It should be noted that substantial magnitude equality of informational signals from different layers is obtained not by variation of reflection factor of different layers, but by smallness of reflection factors of all layers including the last one. This optical disc manufactured in accordance with the present invention includes standard plastic replica of polycarbonate 0.4-0.6 mm thick with the relief of the first data layer, covered with low-reflective film with refraction index more than 1.6, e.g. DLC (Diamond-like carbonate), Si, or any other material providing uniform layer.

Preferably, in order to be able to read in the same direction as in any other layer, the spiral of the last data layer should be wound in the opposite direction, which needs a proper nickel stamper.

The following materials could be used as material for replica: polymethylmethacrylate, polyalkylmethacrylates, polyarylmethacrylates, polyalkylacrylates, polyarylacrylates, polyacrylonitrils, polybutadienes, polyizoprenes, polyethylenetereephtalates, polychloroprenes, polyethylenadipates, polyamides, polyethylenterphtalates, polychloroprenes, polyethylenadipates, polyamides, polyvinylchlorides, polyvinylfluorides, polyvinyl alcohol, polyvinylbutiral, polystirols, polyalkylstirols, polyhalogenstirols, polyoximethylenes, polyethilenoxides, polypropylenoxides, polytetramethylenoxide, polytetramethylenadipates, polyvinylnaphtalenes, polyarylates, polytetrafluorethylene, polyurethanes, polymethylsiloxanes, polyvinyalkyl ethers, polyvinylacetates, polyizobutylenes, polyvinylcinnamates, polyvinylphenol and its alkyl and aryl ethers, polyesters, polyvinylpirolidones and/or its copolymers rather than polycarbonate.

Depending on the type of replica material different materials could be used in order to provide substantially uniform low reflective information layer, e.g. DLC, Si, SixCy, SiCyHz, TiO2, TiN, etc. Preferably the range of reflectance of information layers is about 0.5-10%, and more preferably 1-5%. Desired value of reflectance may be obtained by deposition of different thickness of reflective information layer.

In case of three-layer disc the replica of the first layer might be formed on a standard DVD injecting molding-machine from polycarbonate and having thickness of 0.48-0.58 mm. Pit dimensions (length, depth, width, space between paths) may conform to DVD standard. Space between the first and the second, the second and the third layers is about 10-50 μm. Relives of data layers may be covered with composite on the basis of DLC. Replica of the last layer may be of 0.6-0.7 mm thick and may be formed from polycarbonate (the thickness of polycarbonate substrates can vary significantly dependent on convenience and utility of manufacturing process) by injection molding machine from nickel stamper with reverse direction of curling tracks. As a result all layers, including the last is read on drive without switching of disc curling direction. On the last substrate a mark may be made for better matching of layers.

In accordance with another aspect of the present invention, disc surface on the side of the first data layer may be covered with protective layer, e.g. SiO₂ preserving against mechanical damages (scratches, fingerprints) which enables to clean the surface when necessary.

In accordance with still another aspect of the invention, instead of the last layer with data relief a blank polycarbonate substrate of 0.6-0.7 mm thickness may be used.

Additionally, non-active (back) side of the disc surface may be covered with light-absorbing substance (e.g. soot) that absorbs reading laser radiation protecting against spurious reflections. Light-absorbing dye-stuff can be added to the substrate polymer.

In accordance with one aspect of the present invention, the method of multilayer optical disc production may include forming non-expendable plastic stampers (that can be used more than 100 times) by the ordinary for DVD injection molding machine using nickel stampers with relives of corresponding data layer for producing all layers except the first and the last one.

In accordance with another aspect of the present invention, in order to provide more precise matching of layers alignment marks that correspond to the precise location of the center of the particular nickel stamper may be used.

Additionally, of the plastic stampers may be covered with specialized anti-adhesion films, including, for example, Si, SiO2, SiOx, SixNy, SixOyNz, SixCy, SixCyHz, SixFyHz, etc. by plasma chemical deposition or any other sputtering plants.

A low pressure (10-50 Pa) plasma chemical deposition or any other sputtering technique may be used for forming a semi-transparent (low-reflective) information layer, e.g. on the basis of DLC.

At least second information layer may be formed on the relief of the first data layer in the standard bonding machine for DVD from a photopolymer glue, which is selected by viscosity, optical properties, adhesion with adherent surfaces and resolving capacity, e.g. IRR-469 (produced by—UCB group). Moreover, aliphatic acrylo-urethanes, epoxyacrylates, polyester acrylates and urethane methacrylates can be used.

To prevent appearing of bubbles in the process of putting and curing of photopolymer, e.g. preliminary vacuuming is used, as well as atmosphere of helium.

In accordance with another aspect of the present invention, assembling of multilayer disc may be carried out in the opposite order—beginning with the thick substrate with the last informational layer and finishing by the thin substrate with the first informational layer.

An information label on the outer surface of the disc on the side of last data layer may be formed.

Reusable plastic matrixes can be manufactured by the well-known methods, e.g., injection molding, 2P process, hot-embossing etc. The relief of data layers is transferred with the help of the said reusable plastic matrixes with respective content, using, e.g., 2P process. For this purpose one can use, e.g., conventional DVD bonding-machines (manufactured for sale by, e.g., Panasonic, Krauss-Maffei etc.) The photopolymer on which then a plastic matrix is placed is deposited on the rotating substrate, and the rotating speed increases with the excess liquid photopolymer removed due to the centrifugal force and the photopolymer near the disc center is fixed with a vacuum sucker. After the photopolymer layer is smoothened, the UV-light is switched on to cure the photopolymer.

To facilitate removing the plastic matrix it is covered with the anti-adhesive coating, e.g., Si, SiO₂, SiO, SiₓN_{y}, SiₓO_{y}N_{z}, SiₓC_{y}, SiₓC_{y}H_{z}, CₓF_{y}H_{z} and the like that can be applied, e.g., by the Plasma-Enhanced Chemical Vapor Deposition (PECVD) or by most sputtering machines. The SiO₂ coating can also be formed in the oxygen-containing plasma by processing of the coatings SiₓC_{y}, SiₓN_{y}, SiₓC_{y}H_{z} and other silicon-containing films. For further improvement of the coating's anti-adhesive properties it is siliconed using, e.g., dialkyldichloresilanes, trialkyldichloresilanes, arylalkyldichloresilanes, aryldialkylchloresilanes and other siliconing reagents. The siliconing process can also be performed in the liquid phase with the use of solvents, e.g., aromatic or aliphatic hydrocarbons, or without solvents, e.g., by pure dimethylchloresilane; or in the gas phase with the use of siliconing reagents whose vapour pressure is sufficient for an effective siliconing reaction process. The hydroxyl SiO₂ groups of coating are substituted by silicon-organic radicals to the extent necessary to reduce adhesion.

The last to be glued to the finished “sandwich” is a blank substrate or the one with the last data layer relief. It can be dyed with a light-absorbing matter at the reading laser wavelength, e.g., a dye-stuff. As an option its outer surface can be coated with a light-absorbing matter, e.g., soot-black.

Among such coatings' advantages there's also the ecological safety of the technology as well as the easy procedure of cleansing the plasma reactor's chambers.

Such coatings can also be used for manufacturing discs designed for recording and reading information with the use of blue lasers. Such coatings are deposited, e.g., by Plasma-Enhanced Chemical Vapor Deposition (PECVD) or magnetron sputtering or some other kinds of sputtering machines. For the signals from each layer to be similar and of the required level the thickness of the sputtered layer, e.g., DLC, is selected in the process of sputtering (e.g., in the range of 10-200 nm). Besides DLC, one can use the following coatings: Si, SiₓC_{y}, SiₓC_{y}H_{z}, TiO₂, TiN, as well as other coatings with a high refraction factor and providing substantially uniform layer.

To increase the degree of matching accuracy the initial metal matrixes got the marks indicating the true centers of the information spiral; later the said marks were transferred to substrates and plastic stampers during the injecting molding process. It provides tracking matching precision of 10 μm (in conventional DVDs this accuracy makes 20-40 μm).

If we use a standard DVD lens without a compensator to read the information from a multilayer optical disc, the thickness of the 1^{st} (from the laser beam side) substrate must be reduced compared with the DVD standard and make 0.50-0.58 mm. Manufacturing a multilayer optical disc by varying the thickness of the reflective film, e.g., DLC, on different layers one can make up for the change of the information signal at the expense of spherical aberrations along the focal line of the lens.

Reading device for multilayer optical disc, made in accordance with the present invention preferably includes a compensator of aberration, device of optical and electronic suppression of cross-talks, servo-systems (auto-focusing and auto-tracking) for multilayer discs. Additional software and/or hardware utilities may be used, e.g. HDTV decoder, 3-D transformer, etc. In order to provide reading from multilayer optical disc, produced in accordance with the present invention, sub-milliwatt level signals drive should be used. It should be provided with the option of readjustment to the 2^{nd}, 3^{rd}, 4^{th}, etc. layer e.g. the servo-system (autofocusing).

In order to subdue the interlayer cross-talks (in particular suppressing the interference of coherent laser generated readout signals) the following techniques could be used:

1. Optical filtration provided by the adjustment of the lens and photo detector mutual position;

2. Electronic filtration. Provided by the frequency filtration with the help of electronics (the difference between the information signal frequency and the one of the interlayer crosstalk frequency is big enough);

3. The reduction of the laser radiation time coherence. Provided by the time-modulation of laser radiation.

When the number of layers increased over 3 the additional compensator, could be preferably used, e.g. device that changes the phase spatial profile of the beam in order to subdue aberrations while refocusing from one layer to another. For this purpose one can use either adaptive lenses or double-component lenses, or stationary phase modulators (e.g., liquid crystal ones) that can be fixed outside the optical head so that the design of the head itself doesn't change.

While using multilayer optical discs as carriers for HD Video one can fix a special controller into the drive to decode the compressed by, e.g., MPEG-2 HD Video, etc.

Usually, the existing video-DVD discs use the method of information encoding based on MPEG-2. The demonstration of video DVD-quality requires the reading speed of 6-11 Mbit/sec (variable bit-rate). To get the HD-quality the reading speed must amount to 20-40 Mbit/sec. In Blue Ray discs it is constant and equals 36 Mbit/sec. The Microsoft encoding (WMV9) provides for the reading speed characteristic of the video DVD format yet offering better quality. However, initially the said encoding was designed for viewing HDTV via the computer. Besides, the WMV9 quality is inferior to the one of HDTV by the traffic rate of about 30 Mbit/sec. That is why in our case we use MPEG-2 with the variable bit-rate of 11-34 Mbit/sec to provide the quality comparable with the one of the Blue-Ray disc. However all other types of encoding are also possible and can be readily implemented in the present invention.

It is obvious to those skilled in the art that various changes and modifications are possible, without departing from the spirit and scope of the invention, and that what is briefly claimed is just an example that in any way may limit the inventor rights.

Those skilled in the art will readily appreciate that various modifications and changes may be applied to the embodiment of the invention as hereinbefore exemplified without departing from its scope defined in and by the appended claims.

1. A method for manufacturing of a multi-layer optical carrier, the method comprising:
molding a substrate to have a data layer having a surface relief in a form of information pits and spaces therebetween and coating said data layer with a partially reflective layer to form a substrate structure,
forming on said substrate structure at least one optically transparent layer having a surface relief in a form of information pits and spaces therebetween,
coating said surface of at least one optically transparent layer with a partially reflective layer.

2. The method of claim 1, wherein said at least one optically transparent layer having a surface relief in is formed layer-by-layer on a substrate.

3. The method of claim 1, wherein said at least partially reflective layer including a dielectric material.

4. The method of claim 1, wherein said at least partially reflective layer including a semiconductor material.

5. The method of claim 1, wherein said coating with at least partially reflective layer including a thermal spraying in vacuum.

6. The method of claim 3, wherein the material of partially reflective layer is selected from the group consisting of DLC, SiₓC_{y}, SiC_{y}H_{z}, TiO₂, TiN.

7. The method of claim 4, wherein the material of partially reflective layer being Si.

8. The method of claim 3, wherein said dielectric material having the refractive index different from the refractive index of said optically transparent layers having surface relief.

9. The method of claim 1, wherein said substrate including a polymeric base selected from the group consisting of polymethylmethacrylate, polyalkylmethacrylates, polyarylmethacrylates, polyalkylacrylates, polyarylacrylates, polyacrylonitrils, polybutadienes, polyisoprenes, polyethylenetereephtalates, polychloroprenes, polyethylenadipates, polyamides, polyethylenterphtalates, polychloroprenes, polyethylenadipates, polyamides, polyvinylchlorides, polyvinylfluorides, polyvinyl alcohol, polyvinylbutiral, polystyrenes, polyalkylstyrenes polyhalogenstyrenes, polyoximethylenes, polyethilenoxides, polypropylenoxides, polytetramethylenoxide, polytetramethylenadipates, polyvinylnaphtalenes, polyarylates, polytetrafluorethylene, polyurethanes, polymethylsiloxanes, polyvinyalkyl ethers, polyvinylacetates, polyizobutylenes, polyvinylcinnamates, polyvinylphenol and its alkyl and aryl ethers, polyesters, polyvinylpyrriolidones and/or its copolymers rather than polycarbonate.

10. A method for manufacturing of a multi-layer optical carrier, the method comprising:
molding a first substrate to have a data layer having a surface relief in a form of information pits and spaces therebetween and coating said data layer with a partially reflective layer to form a first substrate structure,
molding at least one additional substrate to have a data layer having a surface relief in a form of information pits and spaces therebetween and coating said data layer with a partially reflective layer to form at least one additional substrate structure,
forming on said at least first substrate structure at least one optically transparent layer having a surface relief in a form of information pits and spaces therebetween,
coating said surface of at least one optically transparent layer with a partially reflective layer, and
placing said first and at least one additional substrate structures in contact with each other with an adhesive material therebetween.

11. The method of claim 10 further comprising forming on said at least one additional substrate at least one optically transparent layer having a surface relief in a form of information pits and spaces therebetween, and coating said surface with a partially reflective layer.

12. The method of claim 10 wherein forming said plurality of optically transparent layers having surface relief including an injection molding.

13. The method of claim 11 wherein forming said plurality of optically transparent layers having surface relief including an injection molding.

14. The method of claim 10 wherein forming said plurality of optically transparent layers having surface relief including a photo polymeric replication.

15. The method of claim 11 wherein forming said plurality of optically transparent layers having surface relief including a photo polymeric replication.

16. The method of claim 10, wherein said at least partially reflective layer including a dielectric material.

17. The method of claim 10, wherein said at least partially reflective layer including a semiconductor material.

18. The method of claim 10, wherein said coating with at least partially reflective layer including a thermal spraying in vacuum.

19. The method of claim 16, wherein the material of partially reflective layer is selected from the group consisting of DLC, SixCy, SiCyHz, TiO2, TiN.

20. The method of claim 17, wherein the material of partially reflective layer being Si.

21-22. (canceled)
